(19) United States
(12) Patent Application Publication
(10) Pub. No.: US 2002/0028229 A1
(43) Pub. Date: Mar. 7, 2002

(54) Antimicrobial compositions

(76) Inventors: John Lezdey, Indian Rocks Beach, FL (US); Jarett R. Lezdey, Indian Rocks Beach, FL (US)

Correspondence Address: VINCENT M. FAZZARI, ESQ., COHEN, PONTANI, LIEBERMAN & PAVANE, 551 FIFTH AVENUE SUITE 1210, NEW YORK, NY, 10176, US

(21) Appl. No.: 09/491,224

(22) Filed: Jan. 25, 2000

(51) Int. Cl. A01N 25/00; A01N 37/00; A01N 33/02; A01N 31/14; A01N 31/00; A01N 31/08

(52) U.S. Cl. 424/405; 424/78.31; 514/663; 514/673; 514/731; 514/574; 514/724; 514/718

(57) ABSTRACT

The invention provides antimicrobial compositions which contain a phenol complex with a film forming complex of a polycarboxylic acid and a microbicide containing at least two quaternary amine groups.

### FIELD OF THE INVENTION

The present invention relates to antimicrobial compositions comprising phenol and diquaternary ammonium complexes. More particularly, there is provided compositions with novel complexes which render the same antimicrobial activity as the unreacted smaller molecule but are more hypoallergenic, have slower release and longer lasting. The complexes are especially useful in killing or deactivating microorganisms on contact and preventing growth of colonies over longer periods of time, including mildew.

### BACKGROUND OF THE INVENTION

There is a need to provide a safe and effective means for preventing viral, fungal and bacterial growth, which can be used on or near a person's body without adverse effects on the user. There is a further need to provide preparations, which will inhibit and/or prevent the growth of disease or odor causing viruses, bacteria and fungus.

There is a further need to provide longer lasting protection against infectious diseases caused by viruses and bacteria. New strains of viruses and bacteria are developing which are resistant to antibiotics. Therefore, it has become important as a defense to kill or deactivate them before infection.

Compositions that contain only phenol compounds, which are initially highly effective, quickly evaporate and provide no after treatment protection against regrowth.

Previously, hexachlorophene was widely used in many preparations to kill bacteria on contact and to prevent growth of bacteria and fungus. Hexachlorophene was included in deodorant compositions, talcum preparations, foot powders, and the like. However, the hexachlorophene when used in direct contact with skin was absorbable. Prolonged exposure to hexachlorophene was considered as being hazardous so that it was withdrawn from use in such compositions.

There is a need to provide film-forming compositions, which are used on or near body parts for preventing bacterial and fungal growth, which does not adversely affect the user.

French Patent No. 2,695,297 discloses a method of disinfecting comprising using a composition containing citric acid, diaminetetraacetic acid and a polymeric biguanide salt.

Japanese Patent Publication No. 1989-22824, discloses a medicament for external use that is fungicidal and exhibits an antibacterial spectrum. The medicament comprises quaternary ammonium salts of polymeric carboxylic acid compounds which are sparingly soluble in water. However, the active component is utilized for its ability to permeate into the cutaneous stratum corneum so that such use cannot be continuous and without medical supervision.

U.S. Pat. No. 4,332,763 to Hempel et al discloses the use of a quaternary ammonium polymer obtained by the reaction of dimethyl sulphate with a mixed polymer of vinyl pyrrolidone and dimethylamino ethylmethacrylate. However, the quaternary ammonium cation of this polymer is leachable and the polymer is slightly soluble so that polymer cannot be used in compositions which contact skin or where long term use is required.

U.S. Pat. No. 3,872,128 to Byck, which is herein incorporated by reference, discloses anti-microbial ammonium polymer salts which are prepared from carboxyl-containing a-olefin polymers and quaternary ammonium salts. The polymers are used to form solid polymeric articles for hospitals and patient care. The compounds do not form antimicrobial films.

U.S. Pat. No. 4,946,672 to Gilbs discloses a disinfectant comprising a biguanide, citric acid and other components.

U.S. Pat. No. 3,404,134 to Rees, which is herein incorporated by reference discloses a process for crosslinking copolymers of alpha olefin and alpha, beta ethylenically unsaturated carboxylic acid units. The copolymers are crosslinked utilizing diamine cations. None of the diamine cations are stated as being anti-microbial. Furthermore, the polymers are used to make molded articles and sheet material.

The term “polycarboxylic acid” is intended to mean carboxylic acid compounds having 2-4 carboxylic acid groups or anhydrides which reacted behave as polycarboxylic acids or salts thereof.

### SUMMARY OF THE INVENTION

The invention provides novel antimicrobial film forming compositions containing complexes which are formed between polycarboxylic acids and non-benzyl containing biocides,having two quaternary ammonium or amine site, or the salts thereof and phenols. The reactions between these functional compounds and the carboxylic acid causes at least one of the quaternary ammonium groups to coordinate or complex per molecule of polycarboxylic acid to form a higher molecule weight compound. These higher molecular weight species possess the full activity of the smaller unreacted functional molecule and do not penetrate the skin. It has been surprisingly found that these complexes further form complexes with phenols so as to provide a longer term of antimicrobial activity of the phenol.

When the complex with the phenol compound is placed in a lower alkanol as a carrier, there is a multiplicity of antimicrobial activity. The alkanol provides the first antimicrobial action, after the alkanol evaporates, the phenol is in greater concentration so as to provide the second antimicrobial activity. After the phenol is released, the film forming complex continues its activity and retards colonization of microbes.

It is therefore an object of the invention to provide a phenol containing long lasting anti-microbial composition.

It is a further object of the invention to provide an anti-microbial composition having a broad spectrum of anti-microbial activity. It is another object of the invention to provide a composition for combating mold and mildew.

### DESCRIPTION OF THE PREFERRED EMBODIMENT

In accordance with the present invention there is provided novel compositions which contain a plurality of complexes including one formed between polycarboxylic acids and a non-benzyl containing functional biocides, all having at least two amine sites.

The reaction between these functional or useful compounds containing the quaternary amine sites and polycarboxylic acids causes at least one functional molecule to coordinate or complex (react) per molecule of polycarboxylic acid. This forms a higher molecular weight molecule. These higher molecular weight species possess the full activity of the smaller unreacted functional molecule but are more hypoallergenic. The formation of these simple but larger complexes has the effect of creating a slower release type of functional compound and the phenol. A complex is also formed with the quaternary ammonium site and the phenol. Therefore, a larger lasting effect is achieved with these complexes without having to use the microbial agent in higher doses or frequent doses.

A preferred antimicrobial compound used in the invention has the general formula:

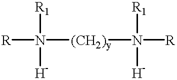

wherein

y is an integer of 1 to 6;

R is hydrogen or an alkyl of 1-15 carbon atoms; and

R₁ is hydrogen or lower alkyl, and the salts thereof.

A preferred antimicrobial compound which is used in the invention is sold by Witco Corp. of Dublin, Ohio under the trademark ADOGEN (N,N,N,N¹,N¹-pentamethyl, N¹-tallow alkyl-1,3-propanamine diammonium chloride; and N-tallow pentamethyl propane diammonium chloride). About 0.4 to 10% by weight of the antimicrobial compound is used.

Benzyl containing antimicrobial compounds are environmentally not suitable.

The use of known phenolic compounds such as phenol or O-phenylphenol in an amount of about 0.4 to 10% by weight of composition provides a broad spectrum of kill in combination with the other complexes of the invention.

The use of the high amounts of phenol compound is particularly useful for compositions that are sprayed into air ducts and vents which are considered as sources for the spread of disease. The phenol not only provides its own antimicrobial activity but improves the antimicrobial capabilities of the film forming complex. The phenol helps to make the film tacky so that the composition adheres to surfaces which are moist or dirty. This feature is especially useful in installations where there is no cleaning or maintenance of the ducts or vents. The phenol further picks up moisture from the air so as to keep the film tacky for longer periods of time. The tacky film holds in the phenol and provides a slow release of phenolic vapors.

After the phenol has evaporated, the film complex of the invention not only provides a surface which prevents regrowth of viruses, bacteria and fungus but still retains the antimicrobial activity of the base quaternary compound.

Polycarboxylic acids useful in the invention contain 2-4 carboxylic acid groups and include: succinic, acrylic, carboxymethyl cellulose, methacrylic, ethacrylic, itaconic, maleic, fumaric, citric, oxalic, and the like. The salts thereof with anions such as citrates, succinates, fumarates, maleates, malonates, malates, etc. can be used. Maleic anhydride and other anhydrides are considered acids for the purposes of the present invention. The succinic acid is the most preferred complexing agent. Sufficient polycarboxylic acid is used to form a complex with the quaternary ammonium compounds and the phenol.

The complex with a polycarboxylic acid and quaternary ammonium compound of the invention can be generally prepared as follows:

A solution of the polycarboxylic acid in water or water-alcohol is formed either as the ammonium or sodium salt with ammonium or sodium hydroxide, respectively. The anti-microbial compound is dissolved in water or a water-soluble solvent. The molecular ratio of anti-microbial compound to sodium or ammonium carboxylate groups in the acid or mixture of acids is adjusted to one or less than one by varying the quantity of solution to be added to the acid solution. The appropriate amounts of the two solutions are mixed with stirring. The complex forms quickly. This complex can be treated with a phenol compound added directly into the composition.

Any of the phenolic compounds which are antimicrobial can be used. It is preferable to use two different phenols so as to have a broader spectrum of antimicrobial activity. Preferred phenols are O-phenylphenol, paratertiary amyl phenol and phenol. The chlorinated phenols can also be used but they are environmentally unacceptable.

The complexes are soluble in water or alcohol. Alcohols as a group possess many desirable features for disinfecting. However, pure alcohol is not as effective as a mixture of alcohol and water. The preferred alcohols are methyl, ethyl and isopropyl alcohol.

The following examples are illustrative of the invention but are not to be construed as to limiting the scope thereof in any manner. The percentages disclosed herein relate to percentages by weight unless otherwise stated.

### EXAMPLE I

Step A. The Following Ingredients were Mixed

| Ingredients | Wt % |
|---|---|
| Ethyl alcohol | 86.5 |
| Succinic acid | 2.5 |
| Phenol (90%) | 0.5 |
| Adogen | 2.0 |
| Water | 8.0 |

A complex is formed between succinic acid and Adogen and the phenol and Adogen complex.

Step B. To the Mixture of Step A were Added the Following

| Ingredients | Wt % |
|---|---|
| O-phenylphenol | 0.5 |
| | 100.0 |

The combination of Step A alone is suitable for use as an antimicrobial composition. However, the combination of Steps A and B provide a composition having a broad spectrum of antimicrobial activity which lasts for at least 28 days.

The pH of the mixture was 6.5. In lieu of ethyl alcohol, water may be utilized especially when the composition is to be used in vents and ducts. Additional phenol may be added so that the resulting film is tacky for use in the vents and ducts.

The composition kills mildew on contact.

### EXAMPLE II

A sanitizing composition for vents and ducts can be prepared by admixing the following ingredients:

| Ingredients | Wt % |
|---|---|
| Water | 88.0 |
| Succinic acid | 5.0 |
| Phenol (90%) | 2.0 |
| Adogen | 3.0 |
| O-phenylphenol | 2.0 |
| | 100.0 |

In lieu of succinic acid there may be used citric acid.

What is claimed is:

1. A film forming composition comprising:
a) the admixture of about 0.4 to 10% by weight of an antimicrobial complex of compound of the formula: 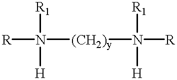
wherein
y is an integer of 1 to 6;
R is hydrogen or an alkyl of 1-15 carbon atoms; and
R₁ is hydrogen or lower alkyl, with a polycarboxylic acid having 2 to 4 carboxylic acid groups;
b) about 0.4 to 10% by weight Of at least one phenol compound;
c) a polycarboxylic acid, have 2 to 4 carboxylic acid groups, and
d) a carrier selected from the group consisting of a lower alkanol and water.

2. The composition of claim 1 comprising two phenols.

3. The composition of claim 2 wherein one of said phenols is O-phenylphenol.

4. The composition of claim 1 wherein said alkanol is an alcohol selected from the group consisting of methyl, ethyl and isopropyl alcohol.

5. The composition of claim 1 wherein said phenol is selected from the group consisting of phenol and O-phenylphenol.

6. The composition of claim 1 wherein said polycarboxylic acid is selected from the group consisting of succinic, citric and tartaric.

7. The composition of claim 1 wherein the phenol content is about 0.1 to 10%.

8. The composition of claim 1 wherein said anti-microbial compound is N,N,N,N¹,N¹-pentamethyl, N¹-tallow alkyl 1,3-propanamine diammonium chloride.

9. An antimicrobial composition comprising the admixture of:
a) about 0.4 to 10% by weight of N,N,N,N¹,N¹-pentamethyl, N¹-tallow alkyl 1,3-propanamine diammonium chloride;
b) about 0.4 to 10% by weight succinic acid;
c) about 0.2 to 5% by weight of phenol;
d) about 0.2 to 5% by weight of ortho phenylphenol, and
e) a carrier selected from the group consisting of water and a lower alkanol.

10. The composition of claim 9 wherein said carrier is water.
